(19) United States
(12) Patent Application Publication
(10) Pub. No.: US 2014/0018135 A1
(43) Pub. Date: Jan. 16, 2014

(54) FANTASY EVENT CONTENT SELECTION SYSTEM

(71) Applicants: Antonio Fernandez, Pompano Beach, FL (US); Patrick Quinlivan, Jacksonville, FL (US)

(72) Inventors: Antonio Fernandez, Pompano Beach, FL (US); Patrick Quinlivan, Jacksonville, FL (US)

(73) Assignee: CBS INTERACTIVE INC., San Francisco, CA (US)

(21) Appl. No.: 13/548,016

(22) Filed: Jul. 12, 2012

(51) Int. Cl. A63F 9/24; A63F 13/00; G06F 17/00

(52) U.S. Cl. 463/3; 463/42; 463/31; 463/4

(57) ABSTRACT

An entertainment content personalization system is described. A method may comprise receiving fantasy data; generating rankings of event content based on the fantasy data and content data associated with the event content; and presenting event content selected based on the rankings on a user interface. Other embodiments are described and claimed.

### BACKGROUND

Fantasy leagues involve competition between multiple fantasy owners based on statistics generated by real events. The most popular fantasy leagues involve sports such as baseball, football, and hockey. In general, fantasy owners manage fantasy teams comprised of players or team segments, such as a defense of a football team. Player and team segment performance translates into statistics used to generate points for the fantasy teams. The better a fantasy team's players perform, the more points are awarded. Fantasy leagues often involve head-to-head competition between fantasy teams. As such, fantasy league participants have a high interest in watching games that may have an impact on their fantasy team or on a competing fantasy team. For example, a player on their fantasy baseball team or a competing fantasy baseball team that is batting during a game.

Access to broadcast and online game content is often limited. In addition, even if a fantasy owner had access to every available game, it is difficult to determine which games may have an impact on their fantasy team at any given time. According to existing technology, a fantasy owner would have to constantly review their fantasy team roster, their opponent's fantasy team roster, and continually flip between live game content in order to locate game situations having an impact on their fantasy team competition. Furthermore, if a fantasy owner elects to watch a particular game, they may be missing out on another game having a greater impact on their fantasy team. It is with respect to these and other considerations that improvements are needed.

### BRIEF DESCRIPTION OF THE DRAWINGS

FIG. 1 illustrates an embodiment of a fantasy event content selection system.

FIG. 2 illustrates an embodiment of a first operating environment for a fantasy event content selection application.

FIG. 3 illustrates an embodiment of a second operating environment for a fantasy event content selection application.

FIG. 4 illustrates an embodiment of a third operating environment for a fantasy event content selection application.

FIG. 5 illustrates a logic flow in accordance with one or more embodiments.

FIG. 6 illustrates a second logic flow in accordance with one or more embodiments.

FIG. 7 illustrates a computing architecture in accordance with one or more embodiments.

FIG. 8 illustrates an embodiment of a communications architecture.

### DETAILED DESCRIPTION

Embodiments are generally directed to fantasy games. A fantasy game is one where participants act as an owner to build a team that competes against other fantasy owners based on statistics generated by real individual players of a game. Fantasy sport is a class of fantasy games. For instance, a fantasy owner might draft a fantasy football team to compete with other fantasy football teams based on statistics generated by real football players from the National Football League (NFL). A common variant uses a computer model to convert statistical performance into points that are compiled and totaled according to a roster selected by a manager of a fantasy team. As with a real team, a fantasy owner is given various online tools to sign, trade and cut fantasy players just like a real team owner.

In general, a game is a system in which players engage in an artificial conflict, defined by rules and a scoring system, resulting in a quantifiable outcome. A fantasy game is a game based on a quantifiable outcome of another game. More particularly, a fantasy game uses a scoring system that is based, at least in part, on a quantifiable outcome of another game in order to obtain a quantifiable outcome for the fantasy game. For instance, a fantasy sport game may comprise a fantasy team selected from human players of a real sport. The fantasy sport game may convert statistical information of human player performance in real sporting competitions (e.g., a football game, a baseball game, etc.) into points that are compiled and totaled according to a roster of a fantasy team. Fantasy players of the fantasy sport game then compete based on the totaled points.

Fantasy games may be based on any type or genre of games. Some examples of games may include without limitation sports, board games, video games, games of chance, lawn games, tabletop games, party games, dexterity games, coordination games, card games, dice games, domino and tile games, guessing games, video games, electronic games, electronic video games, online games, role-playing games, business games, simulation games, television games, reality television games, artificial reality games, and so forth. A fantasy game may be based on any of these or other types of games. A particularly large segment of fantasy games focus on sports, such as football, basketball, baseball, soccer, hockey, racing, and so forth. Recently, emerging fantasy game genres have branched out to include non-sports related games focused on politics, celebrity gossip, movies, and reality television. For instance, fantasy congress is a fantasy game where players, called citizens, could draft members of the United States House and Senate, and keep track of their participation within the U.S. Congress. Actions, especially within the process of making and amending pieces of legislation, of a player's drafted congresspersons are recorded and rated as a cumulative total amount of points against other players. The embodiments are not limited in this context.

Fantasy games may have many fantasy game genres. For example, fantasy sport is a class of fantasy games. A fantasy owner might draft a fantasy football team to compete with other fantasy football teams based on statistics generated by real football players from the National Football League (NFL). Fantasy reality TV is another class of fantasy games. For instance, a fantasy owner might draft a fantasy reality team to compete with other fantasy reality teams based on statistics generated by reality show contestants, such as contestants for such reality shows as Big Brother, Survivor, American Idol, Dancing With The Stars, The Apprentice, Fear Factor, The Amazing Race, and so forth. Fantasy board is another class of fantasy games. For instance, a fantasy owner might draft a fantasy board game team to compete with other fantasy board game teams based on statistics generated by board game contestants, such as chess players, poker players, checker players, monopoly players, or other board games. Fantasy electronic is another class of fantasy games. For instance, a fantasy owner might draft a fantasy electronic game team to compete with other fantasy electronic game teams based on statistics generated by electronic game contestants, such as electronic video game players, electronic gambling game players, and other electronic games. The embodiments are not limited in this context.

Some embodiments are particularly directed to using fantasy game information to selectively access, manage, and present live or recorded media content, such as gaming-related audio and/or video content. For instance, one design goal for fantasy league platforms and content providers is to provide access to event content (e.g., game video footage) based on relevancy and interest to fantasy team owners. As such, techniques designed to meaningfully assess event content in view of fantasy team configurations is desirable.

A popular aspect of fantasy leagues is watching live events having an impact on an owner's fantasy team. For example, if Fantasy Football Team 1 is competing against Fantasy Football Team 2, the fantasy team owners may each be highly interested in watching football games involving players from Fantasy Football Team 1 and Fantasy Football Team 2. However, their interest in each game may not be equal. For example, the owners may be more interested in games featuring players on their team than on the opposing team, or the owners may have more interest in players having a larger scoring impact (e.g., quarterback) than other players (e.g., kicker). Fantasy team owners may not have access to all game content and, even if they did, it would be very difficult to efficiently and meaningfully switch between available game content to locate games and game situations having the highest fantasy impact or owner interest. As such, current fantasy team owners are limited to watching one game, or perhaps switching between another game at various intervals, essentially guessing whether a game is in a situation having a fantasy impact, or viewing textual statistics updates, which does not have the same appeal as watching live events. The effort required to meaningfully track games to determine which may have a fantasy impact sufficient to be of interest would severely detract from the user experience as to make it not worthwhile. It is with respect to these and other considerations that the present improvements have been needed to increase content consumption, build product loyalty, increase online advertising revenue, and attract new content consumers.

Various embodiments are directed to techniques for presenting content of interest to one or more fantasy game elements, including, without limitation a fantasy league, fantasy owner, fantasy team, or a competition between fantasy teams. In one embodiment, content may include substantially live event broadcast or video content for substantially live events associated with the fantasy elements. For example, a football game broadcast and derivations therefrom (e.g., video clips, online video broadcasts, online “live look in” broadcasts, audio broadcasts) may be live event content for a fantasy football element. In another embodiment, information associated with a fantasy element, such as a fantasy team, is used to locate event content relevant to the fantasy element. For instance, relevant event content may comprise content of interest to a user associated with the fantasy element, such as a fantasy team owner. Fantasy element information may include information associated with the fantasy element, including, without limitation, players, teams, team segments (e.g., offense, defense, special teams, hitting, pitching), fantasy competitors, scoring rules, and specified owner preferences. The event content may be associated with content information configured to provide meaningful information about the event content and the situational status of the event content that may be relevant to a fantasy element. For example, the content information may include, but is not limited to, teams, players, game progress, score, situational status, such as which team is on offense or defense, which players are batting, one deck, or on base, whether a team is in a position to score (e.g., the offense of a football team is in the “red zone;” a baseball player is on third base), and whether a game event has occurred leading to a fantasy team score.

According to certain embodiments, the content information may be analyzed in view of the fantasy information to determine content of interest for presentation to an interested user. In one embodiment, the content of interest may comprise event content, such as a game broadcast, video clips of past events, audio information, or combinations thereof. The content of interest may be presented on a user interface, such as a website accessible by a computing device. Alternatively, a media device, such as a television may be tuned to the content of interest, for example, through communication signals sent from a computing device to a television tuner, or some other media device.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

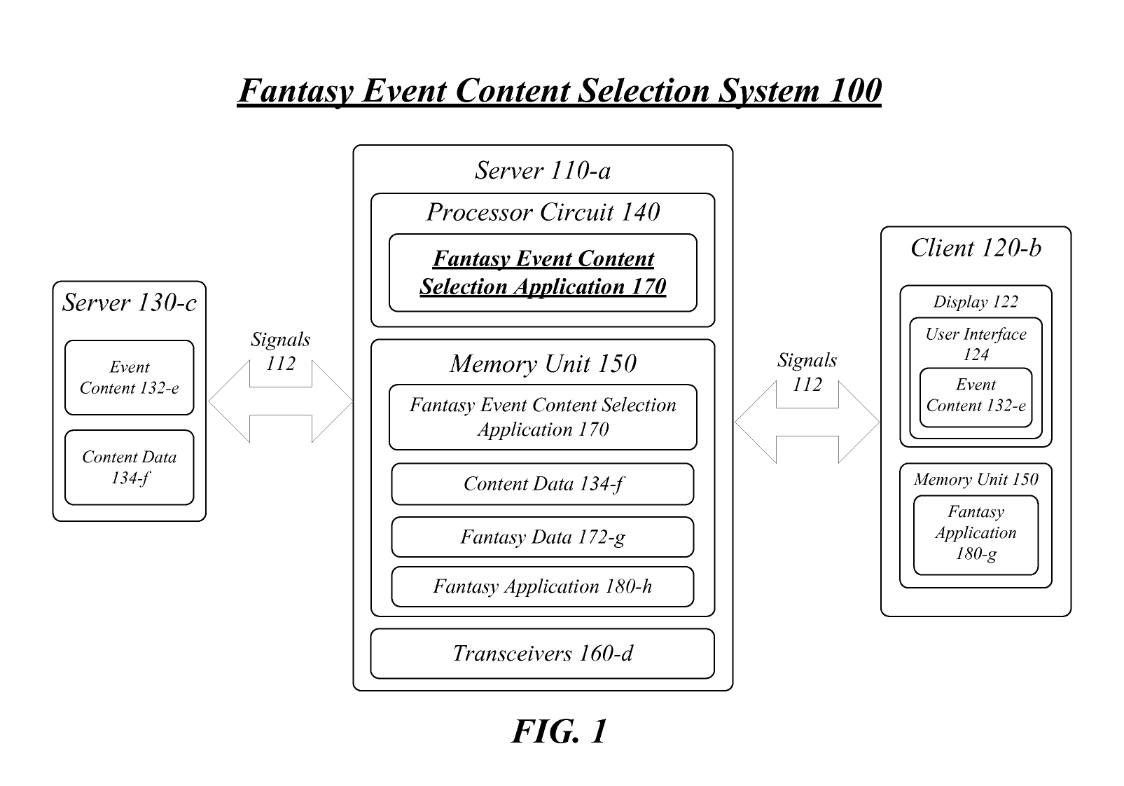

FIG. 1 illustrates a block diagram for a fantasy event content selection system 100. In one embodiment, the fantasy event content selection system 100 may comprise a computer-based system comprising a server 110-a. The server 110-a may comprise, for example, a processor circuit 140, a memory unit 150, and one or more transceivers 160-d. The server 110-a may further comprise a fantasy event content selection application 170. The memory unit 150 may store an unexecuted version of the fantasy event content selection application 170, content data 134-f, fantasy data 172-g, and a fantasy application 180-h. Although the fantasy event content selection system 100 shown in FIG. 1 has a limited number of elements in a certain topology, it may be appreciated that the fantasy event content selection system 100 may include more or less elements in alternate topologies as desired for a given implementation.

It is worthy to note that “a,” “b,” “c” and similar designators as used herein are intended to be variables representing any positive integer. Thus, for example, if an implementation sets a value for a=5, then a complete set of servers 110-a may include servers 110-1, 110-2, 110-3, 110-4, and 110-5. The embodiments are not limited in this context.

In various embodiments, the fantasy event content selection system 100 may comprise multiple computing devices, such as servers 110-a, 130-c and clients 120-b. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, servers 110-a and 130-c may be implemented as a web server and a network server, respectively, accessible over a network, such as the Internet. The client 120-b may be implemented as a desktop computer or a mobile device having a portable power supply and wireless communications capabilities, such as a laptop computer, handheld computer, tablet computer, smart phone, gaming device, consumer electronic, or other mobile device. The embodiments are not limited to these examples, however, and any servers 110-a, 130-c and clients 120-b may be used as desired for a given implementation. The servers 110-a may communicate with other computing devices 130-c, 120-b using communications signals 112 via the transceivers 160-d. The embodiments are not limited in this context.

In various embodiments, the fantasy event content selection system 100 may comprise a processor circuit 140. The processor circuit 140 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 140.

In various embodiments, the fantasy event content selection system 100 may comprise a memory unit 150. The memory unit 150 may store, among other types of information, the fantasy event content selection application 170, content data 134-f, fantasy data 172-g, and a fantasy application 180-h. The memory unit 150 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Event content 132-e may comprise any defined set of electronic information, data, or content capable of being uniquely identified, presented by a user interface 124, or represented by a user interface element of a user interface 124. According to certain embodiments, event content 132-e may comprise video content, including television and radio broadcasts, online video and audio streaming, and audio and video files. The event content 132-e may consist of live event content available in substantially real time, or non-live event content. Event content 132-e may be associated with content data 134-f, for example, comprising data describing one or more features of the content 132-e. One exemplary class of content 132-e may include, without limitation, software computer files, including application files (e.g., document files, word processing files, spreadsheet files, presentation files, etc.), system files (e.g., operating system files, library files, utility files, etc.), and multimedia content files (e.g., audio files, video files, audio/video files, picture files, image files, etc.). Other examples of content 132-e may include without limitation objects presented by a user interface 124, user interface elements, GUI elements, multimedia content (e.g., pictures, images, video, audio, graphics, games, discussion forums, blogs, contests, etc.), software programs, views of software programs, application documents, application content (e.g., a paragraph from a word processing document or work sheet from a spreadsheet document), a web page, a web site, a uniform resource locator (URL) from a web browser, clipboard data, screenshots, device resource data (e.g., sensor data), and so forth. These are merely a few examples, and any type of defined set of electronic information, data, or content may comprise content 132-e as utilized in the fantasy event content selection system 100. The content 132-e may be located on servers 110-a or on a computing device accessible by the servers 110-a, such as one or more of servers 130-c, through the transceivers 160-d. The embodiments are not limited in this context.

Users may access content 132-e through a user interface 124 accessible by a display 122 of a client 120-b. The display 122 may comprise any digital display device suitable for the one or more clients 120-b. For instance, the display 122 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying content 132-e on a user interface 124 to a user of the one or more clients 120-b.

In various embodiments, the servers 110-a may comprise one or more transceivers 160-d. Each of the transceivers 160-d may be implemented as wired transceivers, wireless transceivers, or a combination of both. In some embodiments, the transceivers 160-d may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 160-d may comprise or implement various communication techniques to allow the servers 110-a to communicate with other electronic devices, such as the servers 130-c and the clients 120-b. For instance, the wireless transceivers 160-d may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the servers 110-a may implement different types of transceivers 160-d. Each of the transceivers 160-d may implement or utilize a same or different set of communication parameters to communicate information between various electronic devices. In one embodiment, for example, each of the transceivers 160-d may implement or utilize a different set of communication parameters to communicate information between the servers 110-a and one or more remote devices, such as remote servers 130-c and remote clients 120-b. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 160-d. The embodiments are not limited in this context.

In one embodiment, for example, the transceiver 160-d may comprise a radio designed to communicate information over a wireless local area network (WLAN), a wireless metropolitan area network (WMAN), a wireless wide area network (WWAN), or a cellular radiotelephone system. The transceiver 160-d may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 160-d may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

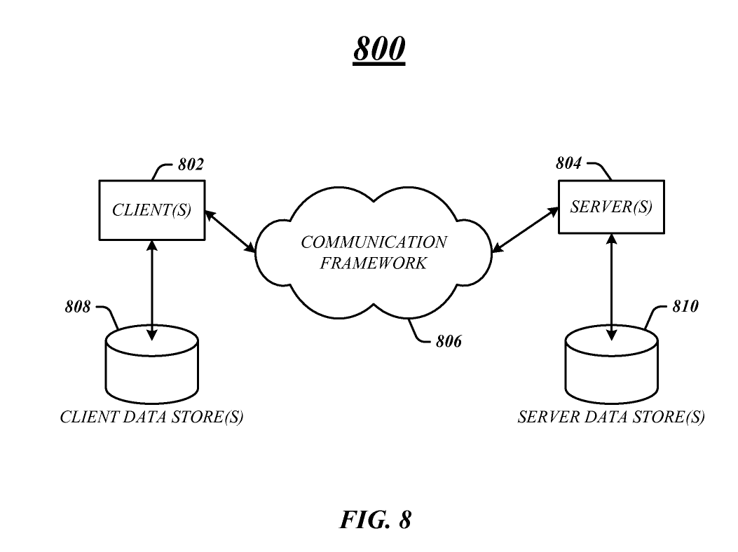

Although not shown, the servers 110-a, 130-c, and clients 120-b may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIG. 8. The embodiments, however, are not limited to these examples.

In the illustrated embodiment shown in FIG. 1, the processor circuit 140 may be communicatively coupled to the transceiver 160-d and the memory unit 150. The memory unit 150 may store a fantasy event content selection application 170 arranged for execution by the processor circuit 140 to present content 132-e to one or more clients 120-b through a user interface 124 via the transceivers 160-d. The servers 130-c and clients 120-b may implement similar elements as the servers 110-a, including a processor circuit 140, a memory unit 150, and transceivers 160-d.

Servers 130-c may be comprised of a memory unit 150 storing content 132-e comprised of content data 134-f. In one embodiment, the content data 134-f may comprise data associated with one or more particular instances of content 132-e. For example, the content data 134-f, may comprise, without limitation, game information, teams, players, game progress information, and game situation information. In one embodiment, the content data 134-f may be generated by the fantasy event content selection application 170 and stored on the server 130-c.

The fantasy application 180-h may operate to manage one or more fantasy elements, such as a fantasy league. For example, the fantasy application 180-g may comprise a fantasy football league comprising multiple fantasy football teams competing according to a specified set of rules. The rules may operate to specify player drafts, player trades, scoring, and team head-to-head competitions. The fantasy application 180-h may access fantasy data 172-g to fill team rosters, determine team scores, approve or disapprove of trades, and to score team competition. The fantasy data 172-g may comprise any data associated with one or more fantasy elements, such as fantasy team, player, owner, and competition data. For instance, fantasy data 172-g for a fantasy application 180-h managing a fantasy baseball league may comprise data including fantasy teams, fantasy owners, baseball teams, players, player statistics, fantasy team players, and competition schedule. In general, the fantasy data 172-g may comprise all data necessary for the fantasy application 180-h to manage and administer all fantasy elements.

The fantasy application 180-h may operate on the server 110-a, the client 120-b, or both. In one embodiment, a client 120-b may access the fantasy event content selection application 170 operating on a server 110-a, and any content 132-e associated therewith, utilizing a web browser application executing on the client 120-b including without limitation Microsoft® Internet Explorer®, Mozilla® Firefox®, Apple® Safari®, and Google Chrome™ browser applications. In another embodiment, a client 120-b may access the fantasy event content selection application 170 operating on a server 110-a utilizing a thin-client application and any associated thin-client hardware accessible by the client 120-b, including, but not limited to, ultra-thin client, web thin client, and mobile thin client implementations. In a further embodiment, the client 120-b may execute its own version of the fantasy application 180-h, such as a mobile application (“app” or “mobile app”) version of the fantasy application 180-h, communicating with the server 110-a to receive fantasy data 134-f.

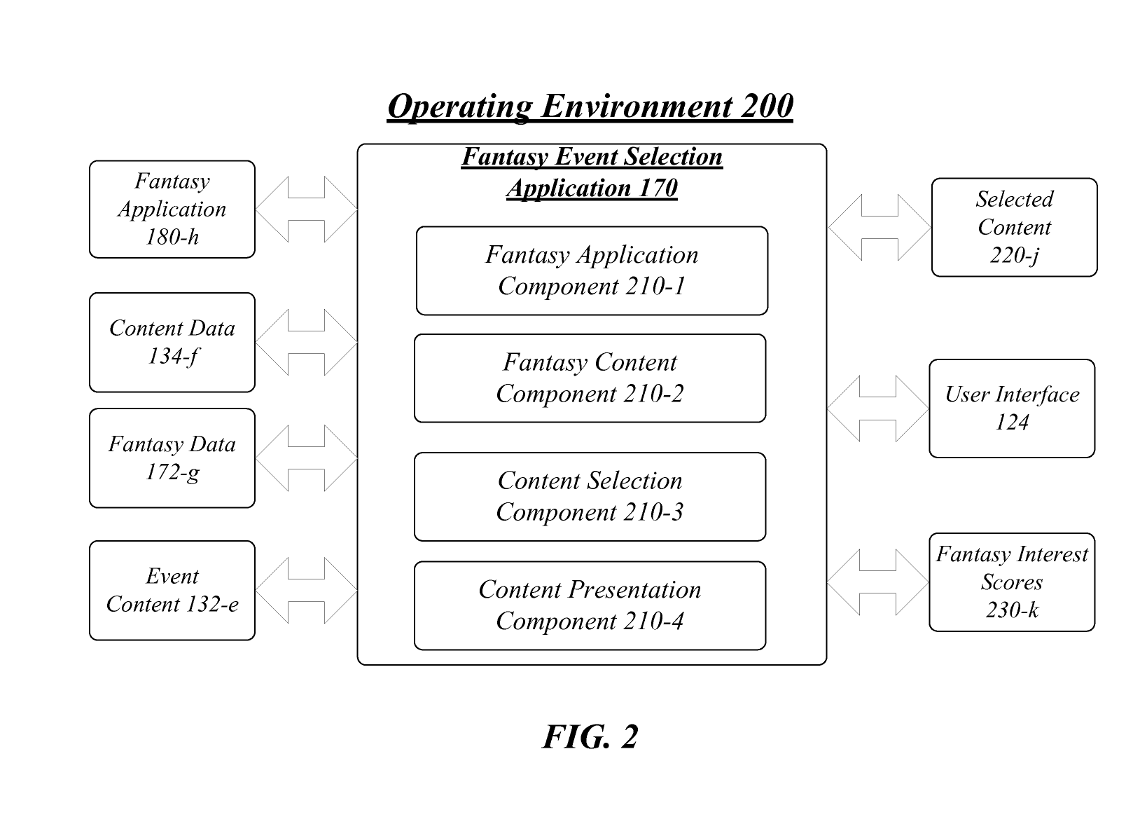

Particular aspects, embodiments and alternatives of the fantasy event content selection system 100 and the fantasy event content selection application 170 may be further described with reference to FIG. 2.

FIG. 2 illustrates an embodiment of an operating environment 200 for the fantasy event content selection system 100. More particularly, the operating environment 200 may illustrate a more detailed block diagram for the fantasy event content selection application 170.

As shown in FIG. 2, the fantasy event content selection application 170 may comprise various components 210-i. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 2, the fantasy event content selection application 170 may comprise an fantasy application component 210-1, a fantasy content component 210-2, a content selection component 210-3, and a content presentation component 210-4. Although the fantasy event content selection application 170 shown in FIG. 2 has only four components in a certain topology, it may be appreciated that the fantasy event content selection application 170 may include more or less components in alternate topologies as desired for a given implementation. The embodiments are not limited in this context.

The fantasy application component 210-1 may generally operate to manage a fantasy application 180-h within the fantasy event content selection application 170. For example, the fantasy application component 210-1 may communicate with a fantasy application 180-h to determine fantasy elements associated with the fantasy application 180-h. The fantasy application component 210-1 may access fantasy data 172-g associated with the fantasy application 180-h. In this manner, the fantasy event selection application 170 may have access to a fantasy application 180-h and fantasy data 172-g associated therewith.

The event content component 210-2 may generally operate to manage event content 132-e for the fantasy event content selection application 170. In one embodiment, the event content component 210-2 may be in communication with servers 130-c hosting event content 132-e, such as live broadcast content, video files, audio files, audio/video files, and combinations thereof. The event content component 210-2 may manage the content data 134-f associated with the event content 132-e. For example, the content data 134-f may comprise the teams playing in a game, player information, game situation information, and the score of the game. According to certain embodiments, the content data 134-f may be generated by the fantasy content component 210-2, obtained from third party sources, or some combination thereof. The event content component 210-2 may access the fantasy data 172-g obtained by the fantasy application component 210-1 to determine which content data 134-f may be of interest for the particular fantasy application 180-h. For example, if the fantasy data 172-g indicates that a particular facet of a game is not relevant for scoring, the event content component 210-2 may not include information relevant to the facet in the content data 134-f.

The content selection component 210-3 may generally operate to determine which event content 132-e should be the selected content 220-j chosen for presentation to fantasy application 180-h users. The content selection component 210-3 may process the fantasy data 134-f managed by the event content component 210-2 and the content data 134-f managed by the event content component 210-2 to generate the selected content 220-j.

For example, a user may be associated with a first fantasy baseball team competing against a second fantasy baseball team. The content selection component 210-3 may access fantasy data 134-f associated with the first fantasy baseball team and the second baseball team, such as the players on the fantasy baseball rosters, scoring rules for the associated fantasy application 180-h, and any user preferences (e.g., preferred teams, players, or game situations). The content selection component 210-3 may access the content data 132-f for the event content 132-e relevant to the first and second fantasy baseball teams (e.g., MLB® baseball game event content 132-e). The event content 132-e may be associated with a fantasy interest score 230-k configured to indicate the potential interest of a participant in each instance of event content 132-e. In one embodiment, the content selection component 210-3 may generate a fantasy interest score 230-k by assigning weights to the fantasy data 172-g, including, without limitation, players, scoring plays, game situations, user preferences, and statistics. In general, the more likely the event content 132-e will be of interest to a participant, the higher the fantasy interest score 230-k. For example, if baseball game event content 132-e comprises content data 134-f that a player for the first fantasy baseball team is batting, the fantasy interest score 230-k for that baseball game event content 132-e may be increased.

Additional factors may affect the interest score 230-k, including, without limitation, the score of the game, the score of the fantasy competition, players, user preferences, and combinations thereof. For example, baseball game event content 132-e where players on the first fantasy baseball team roster are active may be assigned a certain number of points (e.g., 20). If player A for the first fantasy baseball team is pitching in game 1 event content 132-e, the fantasy interest score 230-k for that game may be increased (e.g., by 50 points). If player B for the first fantasy baseball team is up to bat in game 2 event content 132-e, the fantasy interest score 230-k for that game while player B is batting may be increased (e.g., by 100 points) and decreased proportionally after the at bat for player B is over. In this manner, each instance of event content 132-e may be scored and ranked, and chosen as selected content 220-j by the content selection component 210-3. The actual numerical values and point assignments for the fantasy interest score 230-k are not limited as the examples provided herein are for illustrative purposes only. Embodiments are not limited in this context.

The content presentation component 210-4 may generally operate to present the selected content 220-j to one or more users. In one embodiment, the selected content 220-j may be presented as video, audio, audio/video content on a user interface 124. For example, the user interface 124 may comprise a website configured to present event content 132-e. The content presentation component 210-4 may present the selected content 220-j on the website, for instance, as a video stream of a live baseball game broadcast. In another embodiment, the content presentation component 210-4 may send communication signals to a media device, such as the tuner for a television, to tune the television to view the selected content 220-j, such as a live television broadcast of a baseball game.

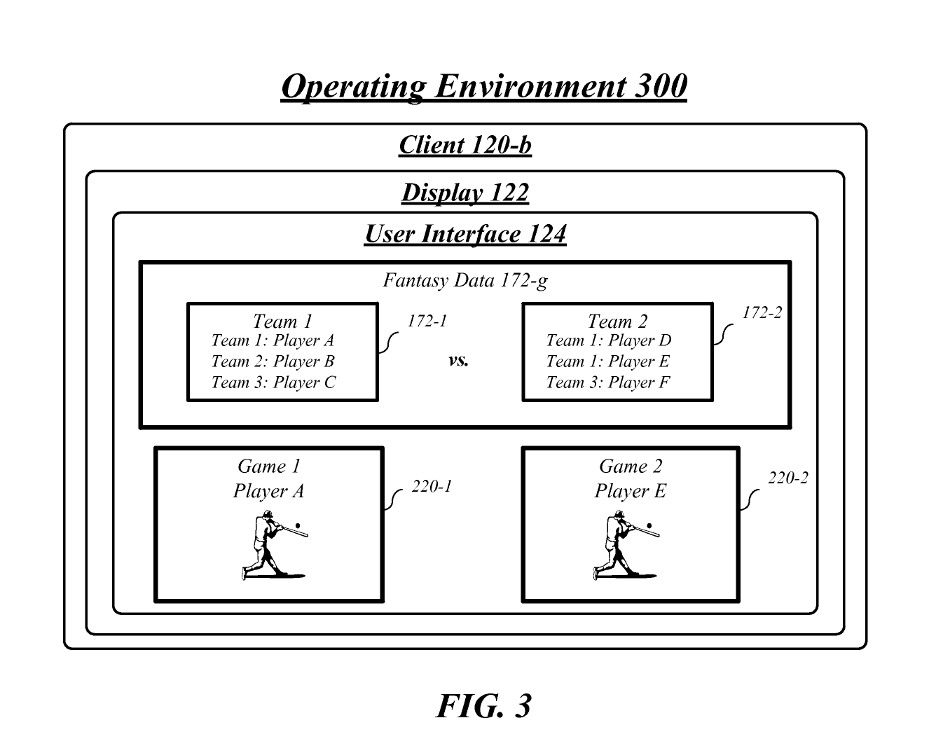

FIG. 3 illustrates an embodiment of an operating environment 300 for the fantasy event content selection system 100. More particularly, the operating environment 300 may illustrate a user interface 124 comprising selected content 220-j provided according to embodiments described herein.

In the illustrated embodiment shown in FIG. 3, the user interface 124 may be presented to a user via a display 122 coupled to a client 120-b. For example, the user interface 124 may comprise an application interface for an application associated with a fantasy application 180-h or a content provider (e.g., MLB®, NFL®, CBS®, ESPN®), such as a mobile app configured for a mobile computing device. In another example, the user interface 124 may comprise a website associated with a fantasy application 180-h or a content provider. In the example of FIG. 3, fantasy data 172-1, 172-2 for two competing fantasy teams (i.e., Team 1 and Team 2) are presented on the user interface 124. In this manner, competitors may follow their teams and the progress of the competition, such as individual and team scoring, through the user interface 124. As depicted in FIG. 3, the selected content 220-1, 220-2 generated by the content selection component 210-3 may be presented on the user interface 124. According to embodiments, the selected content 220-j presented on the user interface 124 is not static as the displayed selected content 220-j may be updated as the games progress, start, end, and game situations change. For example, selected content 220-1 may have a high fantasy interest score 230-k during a specific game situation, such as Player A being up to bat. When the game situation is over, the fantasy interest score 230-k may be adjusted. For instance, the fantasy interest score 230-k for selected content 220-1 may be decreased by 50 points if Player A is out and no longer up to bat, and may be decreased by 20 points if Player A is on base but is no longer up to bat. Accordingly, selected content 220-1 may be replaced by other event content 132-e having a higher fantasy interest score 230-k.

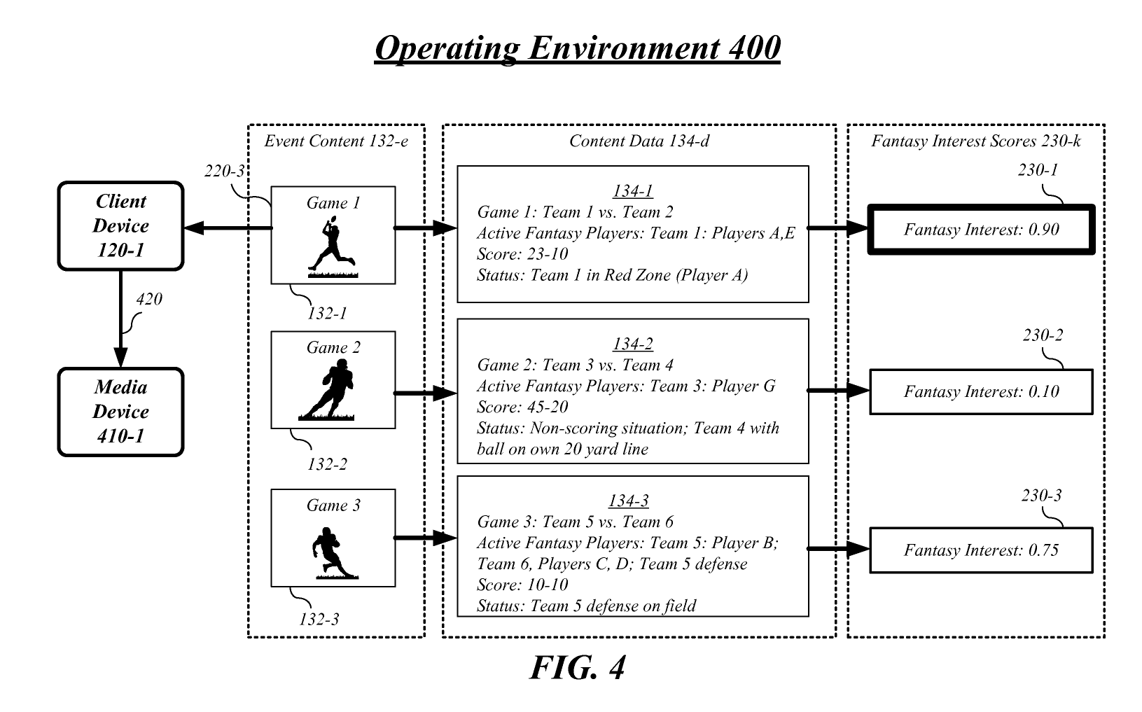

FIG. 4 illustrates an embodiment of an operating environment 400 for the fantasy event content selection system 100. More particularly, the operating environment 400 may illustrate a more detailed example of generating selected content 220-j for consumption by a client 120-b.

FIG. 4 illustrates content data 134-f for multiple instances of event content 134-f. In the example embodiment of FIG. 4, the event content 134-f may involve content for football games, such as NFL® football games for a fantasy football fantasy application 180-h. The event content component 210-2 associates each instance of event content 132-1, 132-2, 132-3 with content data 134-1, 134-2, 134-3. For example, the content data 134-1, 134-2, 134-3 may comprise teams, players, scores, yardage, scoring players, scoring plays, and game status information likely to have an impact on one or more relevant fantasy teams. The content selection component 210-3 may generate fantasy interest scores 230-1, 230-2, 230-3 for one or more fantasy elements, such as a particular fantasy team or fantasy team owner. For example, the content data 134-1 may indicate that an active fantasy player may be in a scoring situation for event content 132-1 (e.g., the team of an offensive player may be within twenty yards of the end zone (i.e., the “red zone”)). As such, the fantasy interest score 230-1 may be higher for event content 132-1. Alternatively, a fantasy interest score 230-2 may be lower for event content 132-2 wherein no active fantasy player is in a scoring situation. The fantasy interest scores 230-1, 230-2, 230-3 may be ranked and the event content 132-1 associated with the highest fantasy interest score 230-k may be the selected content 220-3. In one embodiment, the selected content 220-3 may be transmitted to a client 120-b for presentation on a user interface 124 on a display 122 accessible by the client 120-b. In another embodiment, the client 120-b may be notified of the selected content 220-3 and the client 120-b may transmit communication signals 420, for example, WiFi® signals, to a media device 410-1, such as a tuner for a television set. The tuner for the television set may tune the television to a channel broadcasting the selected content 220-3.

Although professional sports have been utilized as examples herein, embodiments are not so limited, as any events and event content capable of operating according to embodiments are contemplated herein. For example, fantasy elements may involve, without limitation, collegiate sports (e.g., National Collegiate Athletic Association (NCAA®)), financial markets, law, government, reality television, celebrities, and real estate.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

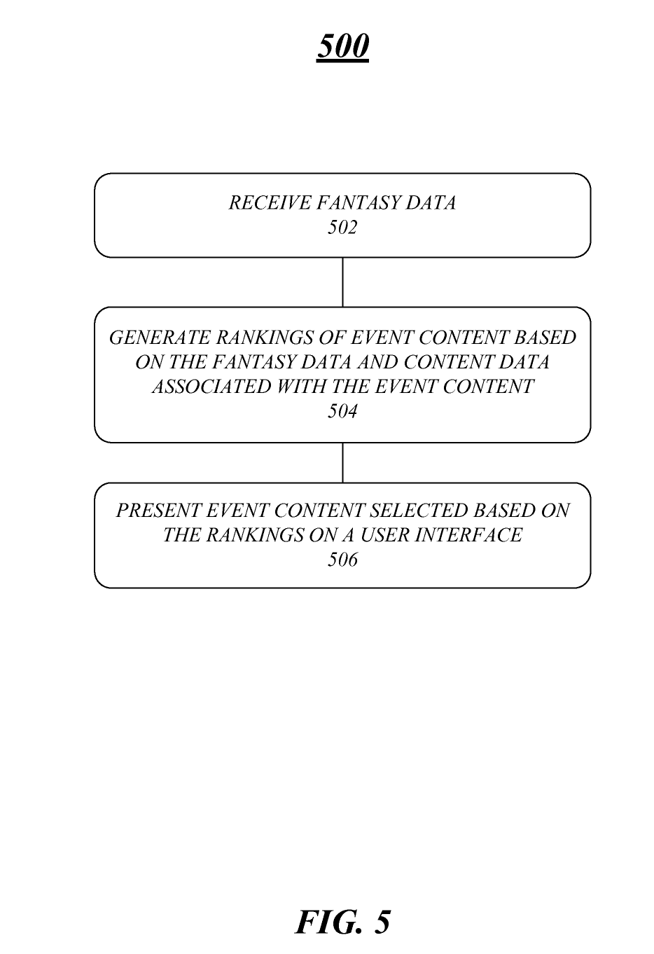

FIG. 5 illustrates one embodiment of a logic flow 500. The logic flow 500 may be representative of some or all of the operations executed by one or more embodiments described herein. For example, the logic flow 500 may illustrate operations performed by the fantasy event content selection system 100.

In the illustrated embodiment shown in FIG. 5, the logic flow 500 may receive fantasy data at block 502. For example, the fantasy application component 210-1 may receive fantasy data 172-g resident on server 110-a. The fantasy data 172-g may be associated with a fantasy application 180-h, such as a fantasy football, baseball, or hockey application.

The logic flow 500 may generate rankings of event content based on the fantasy data and content data associated with the event content at block 504. For example, the content selection component 210-3 may rank instances of event content 132-e based on the fantasy data 172-g. The event content component 210-2 may associate the event content 132-e with content data 134-f configured to provide information indicating a potential interest in event content 132-e by a fantasy application 180-g user. In one embodiment, the event content 132-e may be associated with content data 134-f generated by a third party (e.g., MLB®, NFL®, NCAA®). The content selection component 210-3 may analyze the content data 134-f in view of the fantasy data 172-g to generate a fantasy interest score 230-k for each instance of event content 132-e (e.g., for each game or other relevant event, such as the market close for a fantasy stock market application). According to embodiments, the event content 132-e may be ranked according to the fantasy interest scores 230-k and one or more instances of event content 132-e may be chosen as selected content 220-j based on the ranking.

The logic flow 500 may present event content selected based on the rankings on a user interface at block 506. For example, the content presentation component 210-4 may present selected content 220-j chosen based on the ranking of fantasy interest scores 230-k. In one embodiment, the selected content 220-j may be presented on a user interface 124 through a display 122 accessible by a client. In another embodiment, the client 120-b may be notified of the selected content 220-j by the server 110-a, and may send communication signals 420 to a media device (e.g., television tuner) for presentation of the selected content 220-j.

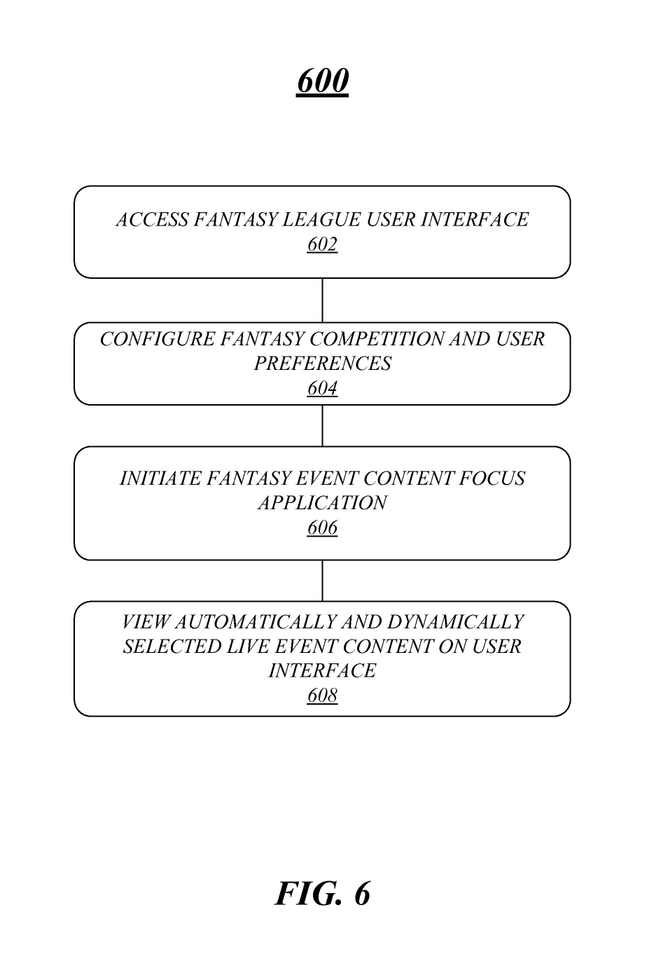

FIG. 6 illustrates one embodiment of a logic flow 600. The logic flow 600 may be representative of some or all of the operations executed by one or more embodiments described herein. For example, the logic flow 600 may illustrate operations performed by the fantasy event content selection system 100.

In the illustrated embodiment shown in FIG. 6, the logic flow 600 may access a fantasy league user interface at block 602. For example, a user may access a user interface 124 for the fantasy application 180-h from a client 120-b. The user interface 124 may provide access, for instance, through one or more graphical user interface (GUI) elements, to the fantasy data 172-g. In this manner, a user may access aspects of one or more fantasy elements, such as a fantasy league, fantasy team, or fantasy team match-up.

The logic flow 600 may configure a fantasy competition and user preferences at block 604. For example, a user may access a fantasy team competition and fantasy data 172-g related thereto (e.g., changing fantasy roster). In addition, the user may configure certain user preferences contained in the fantasy data 172-g associated with their fantasy elements, such as their fantasy team. User preferences may include preferences for generating selected content 220-j, such as preferred teams, players, game situations, and event content 132-e formats (e.g., preferring video over audio-only content, preferring event content over non-event content).

The logic flow 600 may initiate a fantasy event content selection application at block 606. For example, a user may indicate that the fantasy competition may operate with the fantasy event selection application 170 such that selected content 220-j may be presented to the user through the user interface 124.

The logic flow 600 may view automatically and dynamically selected live event content on a user interface at block 608. For example, the user may view selected content 220-j automatically and dynamically generated by the content selection component 210-3 on a user interface 124 presented on a display 122 coupled to a client 120-b. In one embodiment, the selected content 220-j may comprise live, or substantially live, event content 132-e, including live television or online broadcasts of video, audio, or audio/video content.

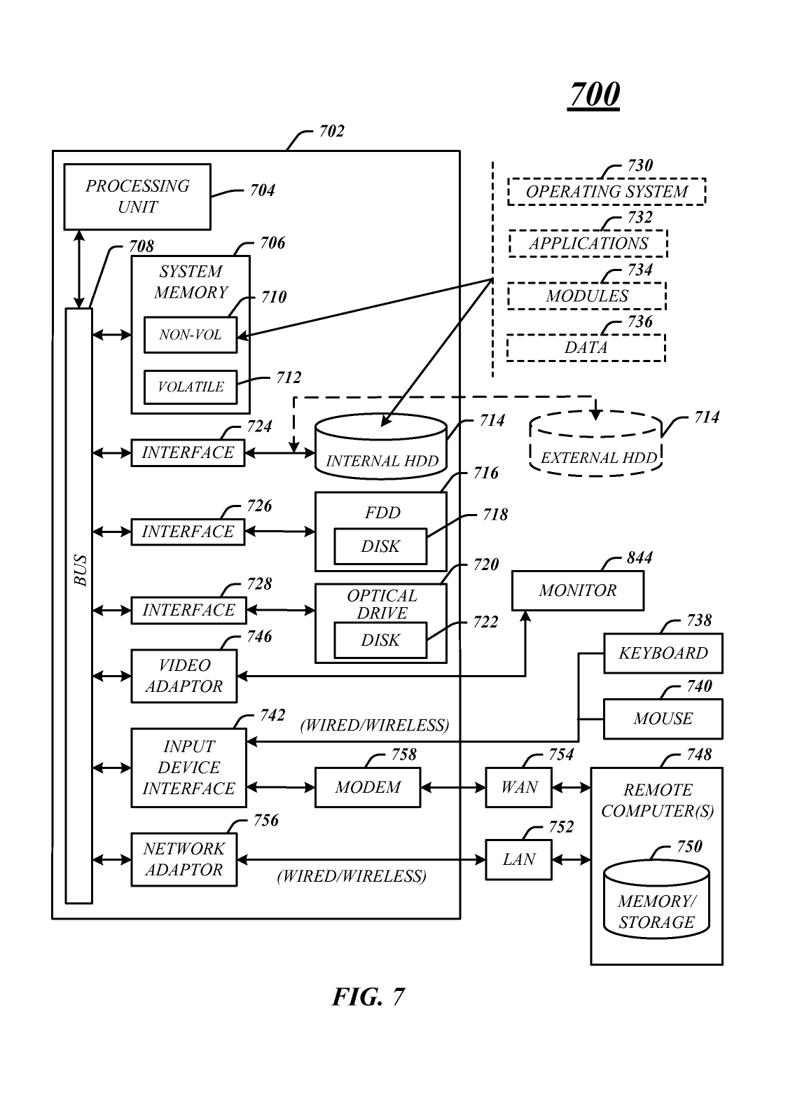

FIG. 7 illustrates an embodiment of an exemplary computing architecture 700 suitable for implementing various embodiments as previously described. In one embodiment, the computing architecture 700 may comprise or be implemented as part of servers 110-a, servers 130-c, or clients 120-b.

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, such as those described with reference to the processor circuit 140 shown in FIG. 1.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 100.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

FIG. 8 illustrates a block diagram of an exemplary communications architecture 800 suitable for implementing various embodiments as previously described. The communications architecture 800 includes various common communications elements, such as a transmitter, receiver, transceiver, radio, network interface, baseband processor, antenna, amplifiers, filters, and so forth. The embodiments, however, are not limited to implementation by the communications architecture 800.

As shown in FIG. 8, the communications architecture 800 comprises includes one or more clients 802 and servers 804. The clients 802 may implement the client 120-b. The servers 804 may implement summary engine device 110, and publication site 140. The clients 802 and the servers 804 are operatively connected to one or more respective client data stores 808 and server data stores 810 that can be employed to store information local to the respective clients 802 and servers 804, such as cookies and/or associated contextual information.

The clients 802 and the servers 804 may communicate information between each other using a communication framework 806. The communications framework 806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 802 and the servers 804 may include various types of standard communication elements designed to be interoperable with the communications framework 806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 802 and a server 804 can be in the form of a data packet adapted to be transmitted between two or more computer processes. The data packet may include a cookie and/or associated contextual information, for example.

The various elements of the fantasy event content selection system 100 as previously described with reference to FIGS. 1-8 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method comprising:
receiving fantasy data;
generating rankings of event content based on the fantasy data and content data associated with the event content, the content data comprising a situational status of the event content, the ranking generated based on a determination of which event content has the situational status with higher fantasy impact; and
presenting event content selected based on the rankings on a user interface.

2. The computer-implemented method of claim 1, presenting event content comprising presenting substantially live video content.

3. The computer-implemented method of claim 1, further comprising assigning weights to the fantasy data according to fantasy participant interests.

4. The computer-implemented method of claim 1, the fantasy data associated with a fantasy application.

5. The computer-implemented method of claim 4, the fantasy application comprising at least one of a fantasy baseball application and a fantasy football application.

6. The computer-implemented method of claim 5, the fantasy data comprising at least one of:
user preferences;
fantasy rules;
a fantasy competitor; and
a fantasy roster.

7. The computer-implemented method of claim 5, the content data comprising at least one of:
a team;
a player;
a score; and
a game situation.

8. An apparatus, comprising:
a transceiver;
a processor circuit coupled to the transceiver; and
a memory unit coupled to the processor circuit, the memory unit to store a fantasy event selection application operative on the processor circuit to present event content associated with a fantasy team on a user interface, the entertainment content personalization application comprising:
a fantasy application component operative to receiving fantasy data;
a fantasy content component operative to associate event content with content data;
a selection component operative to generate rankings of event content based on the fantasy data and content data, the content data comprising a situational status of the event content, the ranking generated based on a determination of which event content has the situational status with higher fantasy impact; and
a user interface component operative to presenting event content selected based on the rankings on a user interface.

9. The apparatus of claim 8, the user interface component operative to present event content comprising substantially live video content.

10. The apparatus of claim 8, the fantasy application component operative to assign weights the fantasy data according to fantasy participant interests.

11. The apparatus of claim 8, the fantasy data associated with a fantasy application.

12. The apparatus of claim 11, the fantasy application comprising at least one of a fantasy baseball application and a fantasy football application.

13. The apparatus of claim 12, the fantasy data comprising at least one of:
user preferences;
fantasy rules;
a fantasy competitor; and
a fantasy roster.

14. The apparatus of claim 12, the content data comprising at least one of:
a team;
a player;
a score; and
a game situation.

15. At least one computer-readable storage medium comprising instructions that, when executed, cause a system to:
receive fantasy data;
generate rankings of event content based on the fantasy data and content data associated with the event content, the content data comprising a situational status of the event content, the ranking generated based on a determination of which event content has the situational status with higher fantasy impact; and
present event content selected based on the rankings on a user interface.

16. The computer-readable storage medium of claim 15, comprising instructions that, when executed, cause a system to present event content comprising presenting substantially live video content on a website.

17. The computer-readable storage medium of claim 15, comprising instructions that, when executed, cause a system to assign weights the fantasy data according to fantasy participant interests.

18. The computer-readable storage medium of claim 15, the fantasy data associated with a fantasy application.

19. The computer-readable storage medium of claim 18, the fantasy application comprising at least one of a fantasy baseball application and a fantasy football application.

20. The computer-readable storage medium of claim 19, the fantasy data comprising at least one of:
user preferences;
fantasy rules;
a fantasy competitor; and
a fantasy roster.

21. The computer-readable storage medium of claim 20, the content data comprising at least one of:
a team;
a player;
a score; and
a game situation.

22. A computer-implemented method comprising:
accessing, from a client computing device, a fantasy application;
providing fantasy data for the fantasy application; and
receiving event content from a server computing device on a user interface accessible from a display of the client computing device, the event content selected according to rankings of the event content based on the fantasy data and content data associated with the event content, the content data comprising a situational status of the event content, the ranking generated based on a determination of which event content has the situational status with higher fantasy impact.

23. The computer-implemented method of claim 22, the event content comprising substantially live video content.

24. The computer-implemented method of claim 22, the fantasy data being weighted according to fantasy participant interests.

25. The computer-implemented method of claim 22, the fantasy application comprising at least one of a fantasy baseball application and a fantasy football application.

26. The computer-implemented method of claim 25, the fantasy data comprising at least one of:
user preferences;
fantasy rules;
a fantasy competitor; and
a fantasy roster.

27. The computer-implemented method of claim 25, the content data comprising at least one of:
a team;
a player;
a score; and
a game situation.
